(19) United States
(12) Patent Application Publication
(10) Pub. No.: US 2006/0235750 A1
(43) Pub. Date: Oct. 19, 2006

(54) Point-of-sales terminal

(75) Inventor: Masakazu Ito, Kanagawa (JP)

Correspondence Address: FOLEY AND LARDNER LLP;SUITE 500, 3000 K STREET NW, WASHINGTON, DC, 20007, US

(73) Assignee: NEC Infrontia Corporation

(21) Appl. No.: 11/401,950

(22) Filed: Apr. 12, 2006

(30) Foreign Application Priority Data
Apr. 13, 2005 (JP) 2005-115351

(51) Int. Cl. G06Q 30/00

(52) U.S. Cl. 705/14

(57) ABSTRACT

A point-of-sales terminal notifies a purchaser of a usable coupon(s) according to purchased commodities. A memory unit (13) memorizes coupon data sets related to item codes. A processing unit (14) searches the memory unit according to input item codes which are input from a touch panel (11) or an input operation unit (12) and which correspond to the purchased commodities. If a usable coupon data set(s) is found, the processing unit displays it on the touch panel as a search result. When the usable coupon data set is selected by touching the touch panel, the processing unit adopts discount amount or rate represented by the selected coupon data set to sales calculation.

This application claims priority to prior application JP 2005-115351, the disclosure of which is incorporated herein by reference.

### BACKGROUND OF THE INVENTION

This invention relates to a point-of-sales (POS) system, in particular to a POS terminal for a POS system which can execute sales calculation including a discount according to a coupon.

A conventional POS system of this type is configured, to automatically calculate a discount price/charge of an item/service according to a coupon shown/given by a purchaser or user.

When the coupon is shown/given by the purchaser/user, a seller/server inputs specific information (or a coupon number) of the coupon to the POS system. The POS system decides whether the coupon is valid or invalid on the basis of the input coupon number. When the coupon is valid, the POS system discounts the item/service (or reduces the price/charge of the item/service).

Thus, showing/giving the coupon to the seller/server is necessary to receive benefit thereof from the conventional POS system. Accordingly, it is natural that the discount is not made when the purchaser/user does not show/give the coupon to the seller/server. However, it is undesirable that the discount is not made when the purchaser/user forgets carrying the valid coupon or misunderstands applicable scope of the carrying valid coupon.

To avoid such a situation, the seller/server may ask whether the purchaser/user has a coupon or not. However, this is not very effective when the purchaser/user forgets the coupon or misunderstands the validity of the coupon as mentioned above.

Moreover, under existing conditions that various coupons are distributed by many sellers/servers, the seller/server desires to promote use of usable coupons by appropriately notifying existence of the usable coupons to the purchaser/user

The conventional POS system has nothing to prompt the purchaser/user to show/give the usable coupon.

Such a POS system is disclosed in Unexamined Japanese Patent Publication No. 5-166069 or No. 2004-514990.

### SUMMARY OF THE INVENTION

It is therefore an object of this invention to provide a POS terminal and a POS system which can notify a purchaser/user of usable coupons.

Other objects of this invention will become clear as the description proceeds.

According to an aspect of this invention, a point-of-sales terminal comprises a memory unit to memorize a coupon data set including a related item code. An input unit is for inputting an input item code. A searching unit is connected to the memory unit and the input unit and searches the memory unit according to the input item code and the related item code to obtain a searching result. A display unit is connected to the searching unit to display the searching result supplied from the searching unit.

The point-of-sales terminal further comprises a calculating unit to execute sales calculation according to the input item code. The coupon information data set includes a coupon number. The input unit is used for inputting an input coupon number. The calculating unit executes the sales calculation according to the input item code and the input coupon number.

According to another aspect of this invention, a point-of-sales system comprises a host computer and a terminal connected to the host computer. The terminal comprises a memory unit for memorizing a coupon data set including a related item code. An input unit is for inputting an input item code. A searching unit is connected to the memory unit and the input unit and searches the memory unit according to the input item code and the related item code to obtain a searching result. A display unit is connected to the searching unit to display a searching result supplied from the searching unit.

In the point-of-sales system, the terminal further comprises a calculating unit to execute sales calculation according to the input item code. The coupon information data set includes a coupon number. The input unit is used for inputting an input coupon number. The calculating unit executes the sales calculation according to the input item code and the input coupon number.

According to a still another aspect of this invention, a computer program for causing a computer to execute an operation comprises the steps of receiving an input item code; searching a memory unit according to the input item code to retrieve a coupon data set related to the input item code to obtain a searching result; and displaying the searching result.

The computer program further comprises the steps of: receiving an input coupon number; and executing sales calculation according to the input item code and the input coupon number.

### BRIEF DESCRIPTION OF THE DRAWINGS

FIG. 1 is a block diagram showing a configuration of a POS system according to a preferred embodiment of this invention;

FIG. 2 shows structure of a coupon master memorized in a memory of a POS terminal included in the POS system of FIG. 1;

FIG. 3 shows structure of a record included in the coupon master of FIG. 2;

FIG. 4 shows an example of the record of FIG. 3;

FIG. 5 shows structure of a subject item-quantity table included in the record of FIG. 4;

FIG. 6 shows an example of the subject item-quantity table of FIG. 5;

FIG. 7 shows an example of a display screen image on a touch panel included in the POS system of FIG. 1;

FIG. 8 is a flowchart for describing a coupon searching step of an operation executed by a processing unit included in the POS system of FIG. 1;

FIG. 9 shows structure of purchased item information;

FIG. 10 shows an example of the purchased item information of FIG. 9;

FIG. 11 shows structure of a search result buffer;

FIG. 12 shows an example of the search result buffer of FIG. 11;

FIG. 13 shows an example of a search result displayed on the touch panel included in the POS system of FIG. 1; and

FIG. 14 shows an example of a sales accounting result displayed on the touch panel included in the POS system of FIG. 1.

### DESCRIPTION OF THE PREFERRED EMBODIMENT

Referring to FIG. I to 14, a description will be made about a point-of-sales (POS) system according to a preferred embodiment of this invention.

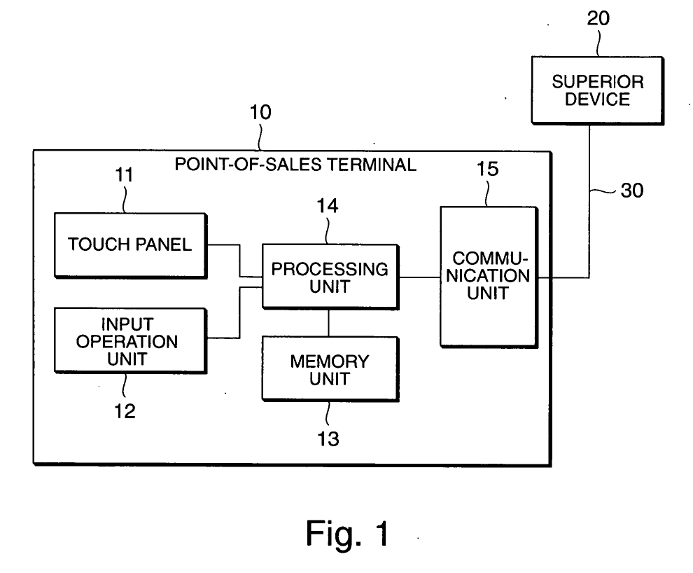

FIG. 1 shows a POS system of the preferred embodiment of the invention. The POS system includes at least one POS terminal 10 and a superior device (i.e. a host computer) 20 which is connected to the POS terminal(s) via a communication line(s) 30.

The POS terminal 10 has a touch panel 11, an input operation unit 12, a memory unit 13, a processing unit 14, and a communication unit 15.

The touch panel 11 serves both as a display unit and a first input unit.

The input operation unit 12 is a ten key, a barcode scanner or the like, and serves as a second input unit.

The memory unit 13 memorizes programs necessary for operations of the POS terminal 10, item information (or item data sets) and coupon information (or coupon data sets).

The processing unit 14 is connected to-the touch panel 11, the input operation unit 12 and the memory unit 13 and performs predetermined processing operations, such as searching the memory unit 13 and executing sales calculation in response to input information from the touch panel 11 and/or the input operation unit 12.

The communication unit 15 is connected to the processing unit 14 and the superior device 20 through the communication line 30 and transmits data between the processing unit 14 and the superior device 20.

The operation of the POS terminal 10 will be described soon. Though the description is made for a case of selling commodities, it can apply to another case of providing services.

First, on inputting an item code from the touch panel 11 or the input operation unit 12, the processing unit 14 searches the memory unit 13 in response to the input item code, If the processing unit 14 detects an item data set corresponding to the input item code, it picks up an item name and a unit price from the item data set to display them on the touch panel 11. In addition, if a numerical quantity is input from the touch panel 11 or the input operation unit 12 after input of the item code, the processing unit 14 calculates the product of the unit price multiplied by the numerical quantity to display it on the touch panel 11.

After that, the processing unit 14 repeats the above-mentioned operation whenever an item code (and numerical quantity) is input from the touch panel 11 or the input operation unit 12. Additionally, the item code may be input by touching a button which is related to the item code and which is displayed on the touch panel 11 together with a corresponding item name.

Next, on inputting a coupon searching command from the touch panel 11 or the input operation unit 12, the processing unit 14 searches the memory unit 13 as mentioned after. If the processing unit 14 detects a coupon data set(s) related to the input item code(s), it causes the touch panel 11 to display the detected coupon data set(s). It is preferable that each coupon data set includes a picture of the corresponding coupon to prompt a purchaser to recall having the coupon.

After that, the processing unit 14 decides whether at least one coupon is selected or not, If one or more coupon data sets are selected, the processing unit 14 adopts the discount amount or rate included in the selected coupon data sets to execute sales calculation.

Subsequently, the processing unit 14 calculates a discount price(s) according to the selected coupon data set(s) and then calculates the total price when a sum command is supplied from the touch panel 11 or the input operation unit 12. Furthermore, the processing unit 14 calculates the change in response to an input paid amount from the touch panel 11 or the input operation unit 12.

Lastly, the processing unit 14 transmits prescribed information regarding above-mentioned accounting procedure to the superior device 20 through the communication unit 15 and the communication line 30.

As mentioned above, the POS terminal 10 (or the POS system) of this embodiment can display a coupon data set(s) on the touch panel 11 according to a purchased item(s). Therefore, the purchaser can be noticed about usable coupon(s) corresponding to the purchased item(s).

In a case where the purchaser shows/gives a coupon(s) beforehand, specific information (or a coupon number(s)) of the coupon(s) may be input from the touch panel 11 or the input operation unit 12 prior to the input of the coupon search command. In such a case, the processing unit 14 searches the memory unit 13 on the basis of the input coupon number(s) to decide whether the coupon(s) is valid or invalid. When the coupon(s) is valid, the coupon data set(s) corresponding to the shown/given coupon(s) is retrieved from the memory unit 13. Then, the processing unit 14 employs the discount amount or rate included in the retrieved coupon data set(s) to execute the sales calculation. Furthermore, the processing unit 14 eliminates the coupon data set(s) having the input coupon number(s) from a search result obtained according to the coupon search command to display the search result.

Though the coupon information is memorized in the memory unit 13 as mentioned above, it may be memorized in a memory (not shown) included in the superior device 20.

Next, the coupon information searching operation of the processing unit 14 will be described in more detail.

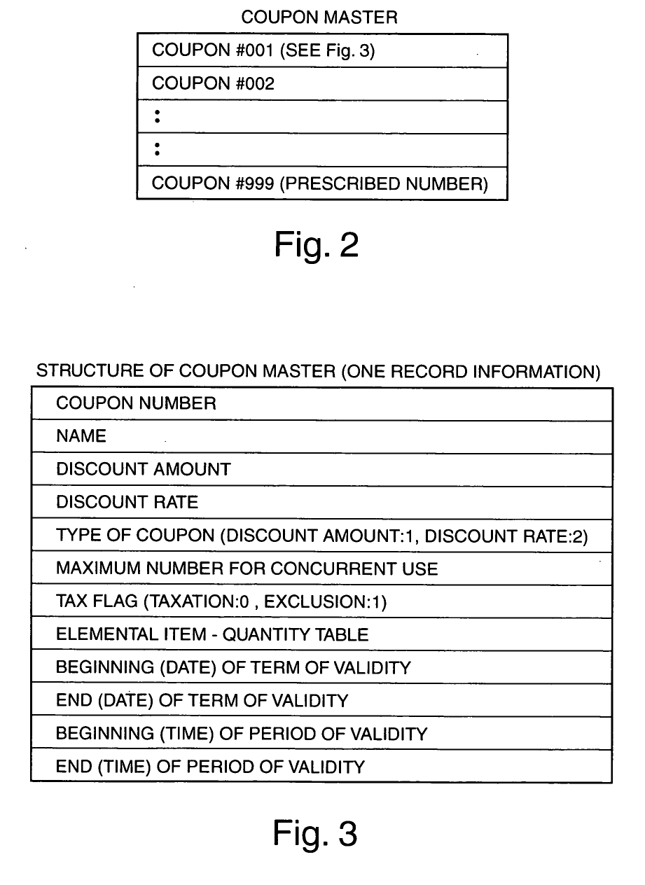

The memory unit 13 stores a coupon master as a group of coupon data sets. As illustrated in FIG. 2, the coupon master has a plurality of records which are assigned with serial numbers (herein #001 to #999). The records correspond to the coupon data sets, separately.

Each record of the coupon master is structured as illustrated in FIG. 3. The record includes items of a “coupon number” and a “subject item-quantity table” and thereby a coupon and a subject item(s) (or an item code(s) of the subject item(s) are related to each other.

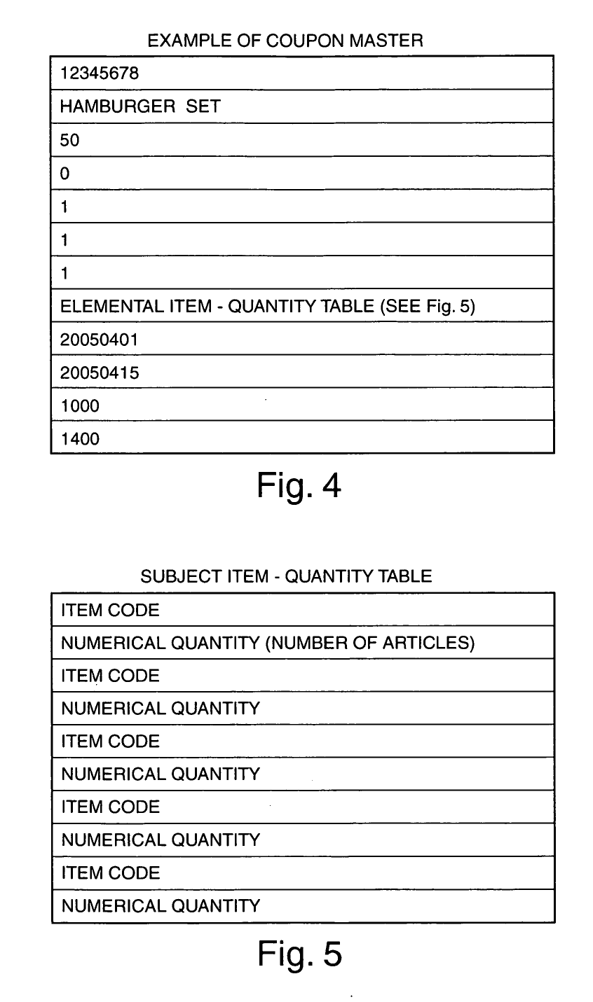

FIG. 4 shows an example of the record of the coupon master. According to FIG. 4, a coupon having a coupon number of “12345678” is related to a hamburger set to reduce price thereof by 50 yen. Furthermore, the coupon is valid from 10 a.m. to 2 p.m., between Apr. 1, 2005 and Apr. 15, 2005.

The “subject item-quantity table” of the coupon master is structured as illustrated in FIG. 5, for example. As shown in FIG. 5, the subject item-quantity table includes at least one combination of items of an “item code” and a “numerical quantity (or the number of articles)” which represents a necessary number to allow use of the corresponding coupon.

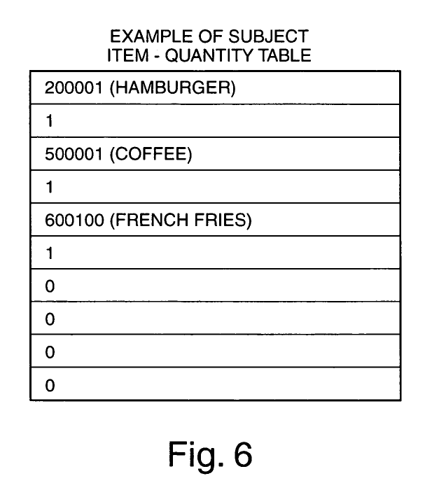

FIG. 6 shows an example of the subject item-quantity table included in the record of FIG. 4. As understood from FIG. 6, the coupon related to the hamburger set can be used when one hamburger, one cup of coffee and one packet of French fries are purchased. That is, the hamburger, the coffee and the French fries are subject commodities of the coupon related to the hamburger set.

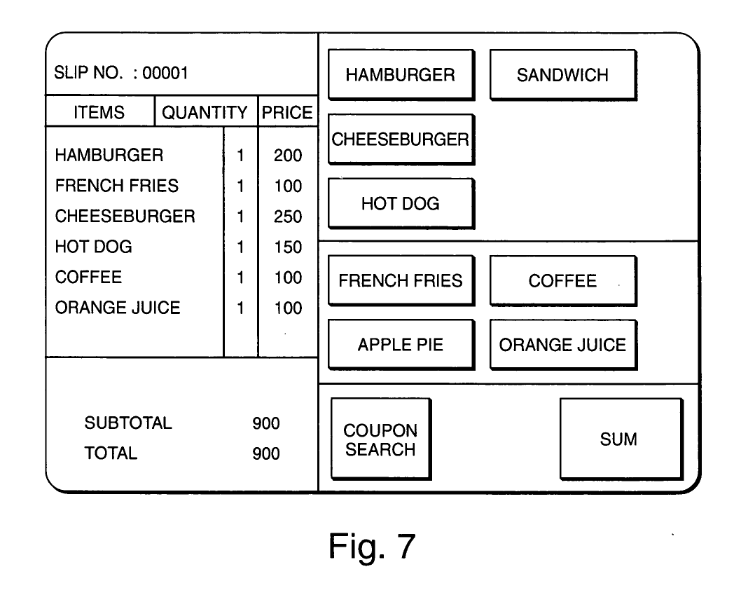

Now, it is assumed that the touch panel 11 displays a screen image of FIG. 7. As shown in FIG. 7, the touch panel 11 displays information for a sales slip at the left side thereof and input buttons at the right side thereof. The information for the sales slip includes items of a “slip NO. (number)”, “items” of purchased commodities, “quantity” of purchased commodities, unit “price” of purchased commodities, a “subtotal”, and a “total”. The input buttons include sales item buttons (or item code input buttons), a coupon search command button and a sum command button.

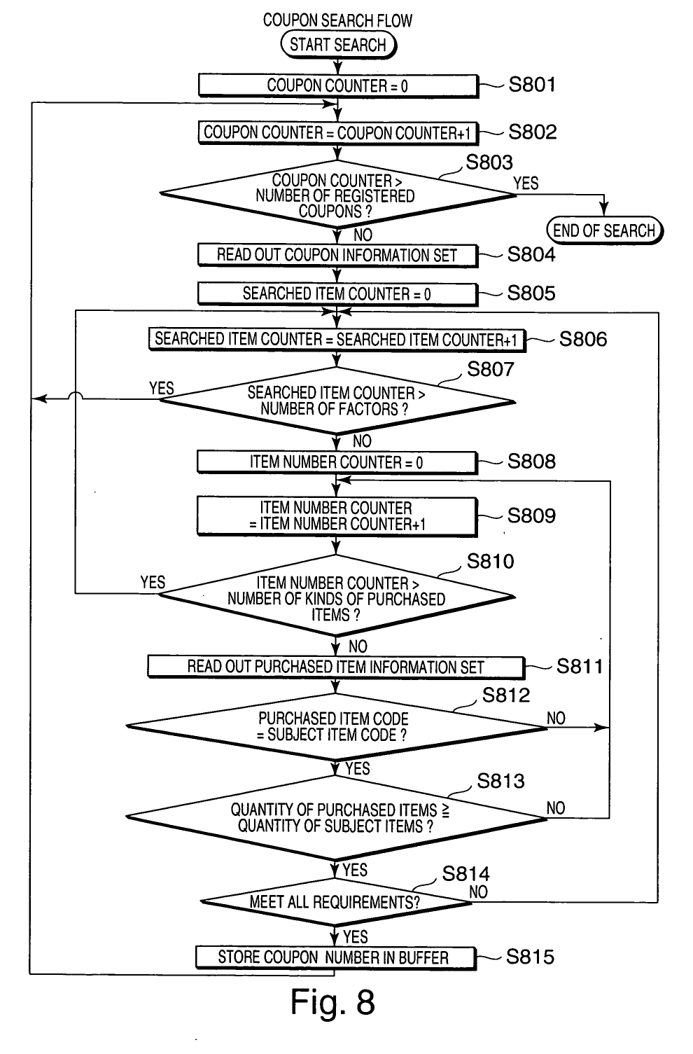

FIG. 7 shows a condition that a hamburger, a packet of French fries, a cheeseburger, a hot dog, a cup of coffee, and a cup of orange juice are purchased. Under the condition, if the coupon search command button is touched, the processing unit 14 searches for the coupon information according to the flowchart of FIG. 8.

At first, the processing unit 14 clears a coupon counter (not shown) thereof at Step S801 and adds one to the coupon counter at Step S802.

The value of the coupon counter is compared with the number of registered coupons at Step S803. The number of the registered coupons represents the number of coupons included in the coupon master of FIG. 2. In other words, the number of the registered coupons is equal to the number of coupon data sets stored in the memory unit 13. If the coupon counter value is equal to or smaller than the registered coupon number, Step S803 goes to Step S804. Otherwise, the search comes to an end.

At Step S804, the processing unit 14 read out the coupon data set having a serial number (#???) which is equal to the coupon counter value.

Subsequently, the processing unit 14 clears a searched item counter (not shown) thereof at Step S805 and adds one to the searched item counter at Step S806. In addition, the processing unit 14 compares the value of the searched item counter with the number of factors at Step S807. The number of factors represents the number of the subject commodities included in the coupon data set read out at Step 804. If the read out coupon data set includes the subject item-quantity table of FIG. 6, the number of factors is equal to “3”. The searched item counter is used to count the number of the subject commodities included in the read out coupon data set. Accordingly, the searched item counter value is related to the subject commodities of the read out coupon data set. For instance, “1”, “2”, and “3” of the searched item counter value corresponds to the commodities of “HAMBURGER”, “COFFEE” and “FRENCH FRIES”, respectively, in the case of the subject item-quantity table of FIG. 6.

When the searched item counter value is larger then the number of factors, Step S807 returns to Step S802. Otherwise, the processing unit 14 clears an item number counter (not shown) thereof at Step S808 and adds one to the item number counter at Step S809.

Next, the processing unit 14 compares the item number counter value with the number of kinds of purchased commodities at Step S810. If the item number counter value is larger than the kind number of the purchased commodities, Step S810 returns to Step S806. Otherwise, Step S810 goes to Step S811. In the case of FIG. 7, the kind number of the purchased commodities is equal to “6”. The item number counter is used to count the number of kinds of the purchased commodities. Accordingly, the value of the item number counter is related to the purchased commodities. For instance, “1”, “2”, “3”, “4”, “5” and “6” of the item number counter values correspond to the purchased commodities of “HAMBURGER”, “FRENCH FRIES”, “CHEESEBURGER”, “HOT DOG”, “COFFEE” and “ORANGE JUICE”, respectively, in the case of FIG. 7.

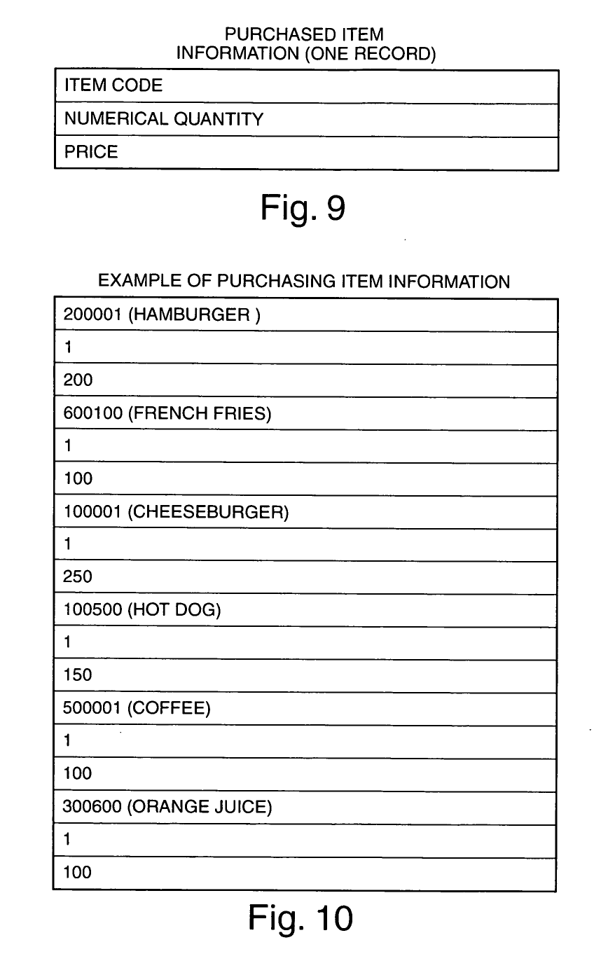

When the item number counter value is equal to or smaller than the number of the purchased commodities, the processing unit 14 reads out a purchased item data set corresponding to the item number counter value from the memory unit 13 at Step S811. The purchased item data set is produced and stored in the memory unit 13 when the item code is input from the touch panel 11 or the input operation unit 12. The purchased item data set, for example, is as illustrated in FIG. 9. In the case of FIG. 7, the purchased item information is as illustrated in FIG. 10. The processing unit 14 reads out one of the purchased item data sets according to the item number counter value at Step S811.

At Step S812, the processing unit 14 compares an item code included in the read out purchased item data set with an item code which is included in the coupon data set read out at Step S804 and which corresponds to the searched item counter value. When the compared item codes are corresponding to each other, Step S812 goes Step S813. Otherwise, Step S812 returns to Step S809.

At Step S813, the processing unit 14 compares quantity included in the purchased item data set read out at Step S811 with quantity which is included in the coupon data set read out at Step S804 and which is of the item corresponds to the searched item counter value. When the compared values of quantity are corresponding to each other, Step S813 goes Step S814. Otherwise, Step S813 returns to Step S809.

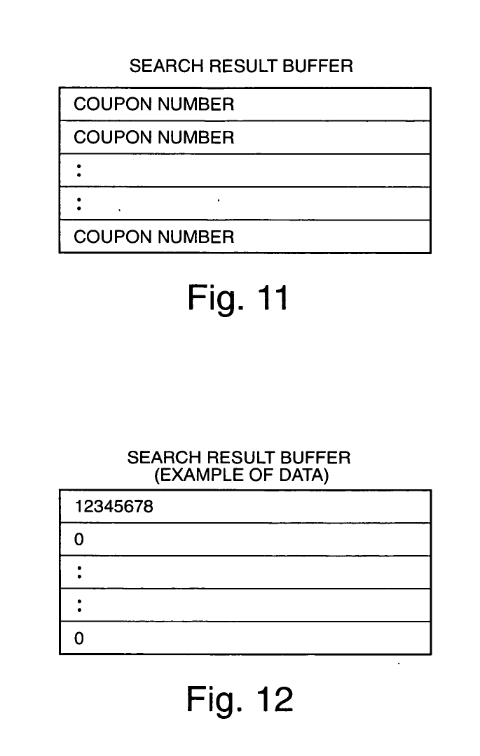

At Step S814, the processing unit 14 decides whether all of the requirements included in the coupon data set read out at Step S804 are met. When all of the requirements of the read out coupon data set are met, the processing unit 14 stores the coupon number of the coupon data set read out at Step S804 in a search result buffer (not shown) at Step S815. The search result buffer, for example, is structured as illustrated in FIG. 11. The search result buffer may be provided in the memory unit 13.

After that, Step S815 returns to Step S802 and the processing unit 14 repeats the operation mentioned above.

As mentioned above, the processing unit 14 read out the coupon data sets one by one from the coupon master and decides whether the coupon corresponding to the read out coupon data set is allowed to be used according to the purchased item(s). Specifically, the processing unit 14 decides whether each subject item of the read out coupon data set is included in the purchased commodities and whether the requirement regarding the quantity of subject item is met by the purchased commodities. Thus, the POS terminal searches the coupon data set(s) corresponding to usable coupon(s) according to the purchased commodities.

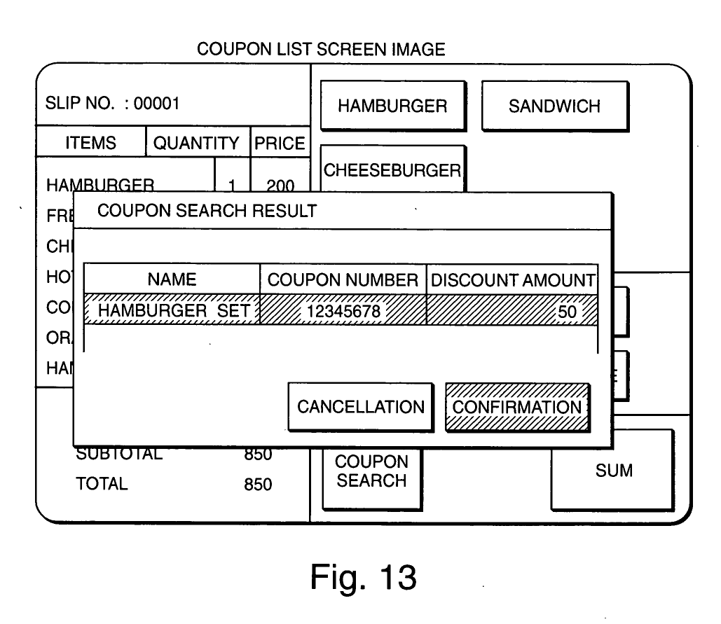

After Step S803 goes to the end, the processing unit 14 retrieves the coupon data set(s) in response to the coupon number(s) stored in the search result buffer. In addition, the processing unit 14 picks out necessary items, such as name and discount amount and so on, from the retrieved coupon data set(s) and display them on the touch panel 11. FIG. 13 shows an example of screen image including the coupon search result.

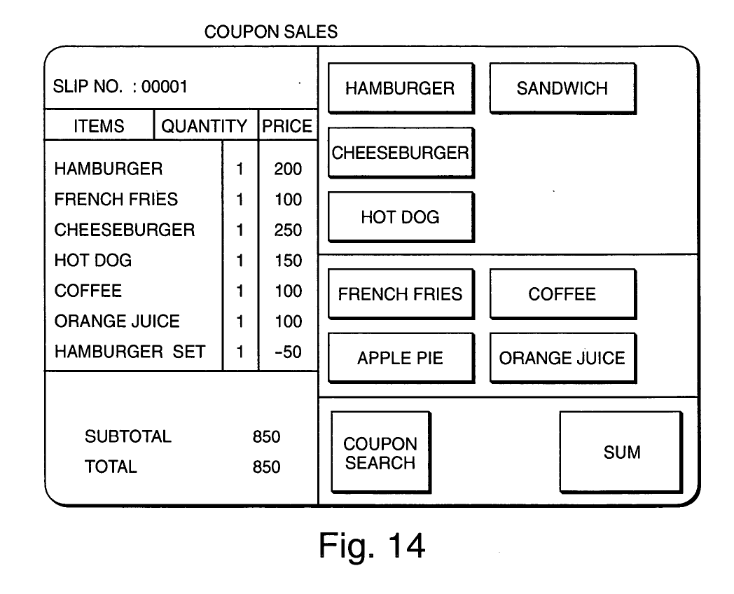

If the purchaser touches any item of the coupon search result displayed on the touch panel 11, the processing unit 14 decides that the coupon data set including the touched item is selected. The processing unit 14 displays the discount amount or rate included in the selected coupon data set on the touch panel 11, and calculates the sum for the purchased commodities again on condition that the coupon is used. As a result, the touch panel 11 displays an image as illustrated in FIG. 14.

While this invention has thus far been described in conjunction with the preferred embodiment thereof, it will readily be possible for those skilled in the art to put this invention into practice in various other manners.

What is claimed is:

1. A point-of-sales terminal comprising:
a memory unit for memorizing a coupon data set including a related item code;
an input unit for inputting an input item code;
a searching unit connected to said memory unit and said input unit for searching said memory unit according to said input item code and said related item code to obtain a searching result; and
a display unit connected to said searching unit for displaying said searching result supplied from said searching unit.

2. A point-of-sales terminal as claimed in claim 1, further comprising a calculating unit for executing sales calculation according to said input item code,
wherein said coupon information data set includes a coupon number; and
wherein said input unit is used for inputting an input coupon number; and
wherein said calculating unit executes said sales calculation according to said input item code and said input coupon number.

3. A point-of-sales terminal as claimed in claim 2, wherein a processing unit serves as both said searching unit and said calculating unit.

4. A point-of-sales terminal as claimed in claim 2, wherein said searching unit eliminates a coupon data set including a coupon number corresponding to said input coupon number from said searching result.

5. A point-of-sales terminal as claimed in claim 2, wherein said display unit comprises a touch panel which serves as at least one part of said input unit.

6. A point-of-sales system comprising:
a host computer; and
a terminal connected to said host computer,
wherein said terminal comprises:
a memory unit for memorizing a coupon data set including a related item code;
an input unit for inputting an input item code;
a searching unit connected to said memory unit and said input unit for searching said memory unit according to said input item code and said related item code to obtain a searching result; and
a display unit connected to said searching unit for displaying a searching result supplied from said searching unit.

7. A point-of-sales system claimed in claim 6, wherein said host computer provides said memory unit in place of said terminal.

8. A point-of-sales system as claimed in claim 6, wherein said terminal further comprises a calculating unit for executing sales calculation according to said input item code, and
wherein said coupon information data set includes a coupon number; and
wherein said input unit is used for inputting an input coupon number; and
wherein said calculating unit executes said sales calculation according to said input item code and said input coupon number.

9. A point-of-sales system as claimed in claim 8, wherein a processing unit serves as both said searching unit and said calculating unit.

10. A point-of-sales terminal as claimed in claim 8, wherein said searching unit eliminates a coupon data set including a coupon number corresponding to said input coupon number from said searching result.

11. A point-of-sales system as claimed in claim 8, wherein said display unit comprises a touch panel which serves as at least one part of said input unit.

12. A computer program for causing a computer to execute an operation comprising the steps of:
receiving an input item code;
searching a memory unit according to said input item code to retrieve a coupon data set related to said input item code to obtain a searching result; and
displaying said searching result.

13. A computer program as claimed in claim 12, further-comprising the steps of:
receiving an input coupon number; and
executing sales calculation according to said input item code and said input coupon number.

14. A computer program as claimed in claim 13, further comprising the step of eliminating a coupon data set including a coupon number corresponding to said input coupon number from said searching result before the displaying step.
